(19) United States
(12) Patent Application Publication
(10) Pub. No.: US 2007/0256093 A1
(43) Pub. Date: Nov. 1, 2007

(54) DECENTRALIZED AND FRAUD-RESISTANT SYSTEM AND METHOD FOR RATING INFORMATION CONTENT

(75) Inventor: John A. HILER, New York, NY (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Xanga.com, Inc., New York, NY (US)

(21) Appl. No.: 11/741,614

(22) Filed: Apr. 27, 2007

Related U.S. Application Data
(60) Provisional application No. 60/795,584, filed on Apr. 28, 2006.

(51) Int. Cl. H04N 5/445; G06F 13/00; G06F 3/00; H04N 7/16

(52) U.S. Cl. 725/28; 725/45; 725/46

(57) ABSTRACT

The present invention is directed to a decentralized, fraud-resistant ratings system for information content, such as World Wide Web or Internet content. The system includes an information content display module for displaying information content and an associated plurality of rating levels to users. The plurality of rating levels are configured for rating the information content by the users. The system includes a rating generation module, in communication with the information content display module, for receiving ratings assigned by the users to the information content in accordance with the plurality of rating levels, for assigning a weight to each user rating in accordance with a historical rating accuracy of each user, and for generating a weighted average consensus rating of the information content in accordance with the weighted user ratings.

The present application claims priority under 35 U.S.C. § 119(e) to U.S. Provisional Application No. 60/795,584, filed on Apr. 28, 2006, the entire contents of which are hereby incorporated by reference herein.

### BACKGROUND

1. Field of the Invention

The present invention relates to content rating systems. More particularly, the present invention relates to a decentralized, fraud-resistant system and method for rating information content, such as Internet or World Wide Web content.

2. Background Information

There has been an explosion in the amount of User-Generated Content (UGC) being created as more and more media is created directly by consumers, including weblogs, photoblogs, video blogs, social network profiles, podcasts, and the like. It is exceedingly difficult to police such a massive amount of content, a problem that will only grow over time as the UGC industry matures.

Most UGC sites, like Xanga.com, are hiring fulltime moderators to do nothing but screen content. Unfortunately, human moderators fail to solve the problem for several reasons. For example, fulltime moderators are very expensive. Furthermore, such censors cannot respond quickly enough to police potentially adult content. In addition, it is difficult to “scale up” and quickly hire as many moderators as needed, particularly given the massive amounts of content that need to be policed. As a result, adult content can be found on most if not every UGC site, even sites that ban such material in their terms of use.

There are additional problems with banning accounts that have borderline adult content. For example, it is difficult to define a precise line as to what constitutes adult content (e.g., whether text erotica constitute adult content, and other similar issues). Additionally, defining and then deleting adult content has the “odious smell of censorship”. Previous attempts to censor media have been eventually rejected by content creators and the community at large, including the Comstock Law that governed obscenity in the U.S. Mail from 1873 to 1936, as well as the “Production Code” (a.k.a., the “Hays Code”) that dictated what was considered morally acceptable for movies from 1920 to 1967.

After 1967, the Hays Code was rolled back and the voluntary, self-regulatory MPAA (Motion Picture Association of America) film ratings system was created. This voluntary ratings system allowed movie makers to create films with more adult content (e.g., R- and X-rated films), but required movie theaters and movie rental outlets to screen viewers for age.

The movie industry has embraced the MPAA film ratings, while the video game industry has similarly embraced the ESRB (Entertainment Software Rating Board) video game ratings. The MPAA film ratings are as follows:
G—General audiences (i.e., all ages admitted).
PG—Parental guidance suggested (i.e., some material may not be suitable for young children).
PG-13—Parents strongly cautioned (i.e., some material may be inappropriate for children under 13).
R—Restricted (i.e., under 17 requires accompanying parent or adult guardian).
NC-17 (i.e., no children 17 and under admitted).
   The ESRB video game ratings are as follows:
E—Everyone (i.e., contains content that may not be suitable for persons under age 6).
E10+—Everyone 10 and older (also known as “Preteen”) (i.e., contains content that may not be suitable for persons under age 10).
T—Teen (i.e., contains content that may not be suitable for persons under age 13).
M—Mature (i.e., contains content that may not be suitable for persons under age 17).
AO—Adults Only (i.e., contains content that is suitable only for persons aged 18 and older).
   (For the ESRB ratings, it is noted that there is an additional rating called EC (Early Childhood) that does not map onto any corresponding MPAA ratings.) Most major media systems have opted for self-regulatory systems like the MPAA and the ESRB ratings schemes. Such ratings systems have allowed media producers to enjoy creative freedom, while balancing that freedom with the need to regulate the access of children and minors to adult-themed content.

However, no such system has emerged for the UGC industry due to the massive amounts of content that need to be policed. The MPAA and the ESRB ratings systems only rate approximately 1000 movies and video games a year. The music industry, which produced 27,000 new releases in 2001, lacks an effective rating system; tellingly, the music industry has been unable to create a system that can quickly rate such a massive amount of content.

MPAA/ESRB-style ratings systems are too centralized to quickly rate massive amounts of content. However, a decentralized ratings system could quickly run into questions of fraud. For example, how could raters be prevented from fraudulently rating content too high or too low? Resolving the tension between decentralization and fraud has so far proved to be an intractable problem. As a result, no self-regulatory system of rating content has emerged for the UGC industry.

### SUMMARY OF THE INVENTION

A decentralized, fraud-resistant system and method for rating information content, such as Internet or World Wide Web content, is disclosed. In accordance with exemplary embodiments of the present invention, according to a first aspect of the present invention, a system for rating information content includes an information content display module. The information content display module is configured to display information content and an associated plurality of rating levels to users. The plurality of rating levels are configured for rating the information content by the users. The system includes a rating generation module in communication with the information content display module. The rating generation module is configured to receive ratings assigned by the users to the information content in accordance with the plurality of rating levels. The rating generation module is configured to assign a weight to each user rating in accordance with a historical rating accuracy of each user. The rating generation module is configured to generate a weighted average consensus rating of the information content in accordance with the weighted user ratings.

According to the first aspect, the rating generation module can be configured to generate the consensus rating of the information content by calculating a mean of the weighted user ratings. Alternatively, the rating generation module can be configured to generate the consensus rating of the information content by calculating a median of the weighted user ratings. The rating generation module can be configured to designate the information content as one of the plurality of rating levels in accordance with the consensus rating. The plurality of rating levels can comprise numerical ratings and/or discrete ratings. For example, the discrete ratings can comprise one of an “A” (“All ages allowed”) rating representing that the information content is suitable for all ages, a “B” (“Basic Guidance”) rating representing that the information content includes material that may not be suitable for young children, a “C” (“Caution”) rating representing that the information content includes material that may be inappropriate for children under a first predetermined age, a “D” (“Discretion Required”) rating representing that the information content is limited to those at least a second predetermined age or minors accompanied by a parent or adult guardian, and an “EX” (“Explicit Content”) rating representing that the information content is not for access by children under the second predetermined age.

According to the first aspect, each rating submitted by each user can be associated with characteristic information for identifying the user. The system can include a characteristic information module in communication with the rating generation module. The characteristic information module is configured to capture the characteristic information associated with the users for generating historical rating information for the users. The rating generation module can be configured to modify the user rating in accordance with the historical rating information of the user. The rating generation module can be configured to determine the historical rating accuracy of each user in accordance with the deviation of the user rating from the consensus rating. The rating generation module can be configured to increase the weight assigned to the user rating when the user rating is within a predetermined deviation from the consensus rating, and to decrease the weight assigned to the user rating when the user rating is outside the predetermined deviation from the consensus rating. The rating generation module can be configured to assign a second weight to the user rating in accordance with a frequency of accurate ratings made by the user. The rating generation module can be configured to assign a third weight to the user rating in accordance with a frequency of inaccurate ratings made by the user. Accordingly, the rating generation module can be configured to generate an overall weight for the user rating by combining the historical accuracy rating weight, the second weight associated with the number of accurate ratings made by the user, and the third weight associated with the number of inaccurate ratings made by the user.

According to the first aspect, the rating generation module can be configured to modify the weight assigned to the user rating in accordance with a length of time that the user has been performing ratings. The rating generation module can be configured to generate an official rating of the information content when the consensus rating exceeds a predetermined threshold. For example, the predetermined threshold can comprise the total number of user ratings submitted for the information content. The system can include a fraud determination module in communication with the rating generation module. The fraud determination module can be configured to screen user ratings for fraud in accordance with the deviation of the user rating from the consensus rating. The rating generation module can be configured to decrease the weight assigned to the user rating when the user rating is determined to be fraudulent by the fraud determination module. The system can include an information content restriction module in communication with the rating generation module. The information content restriction module can be configured to restrict user access to the information content in accordance with the consensus rating. The system can include an age verification module in communication with the information content restriction module. The age verification module can be configured to verify the age of the user. The information content restriction module can be configured to deny user access to the information content when the age of the user is below a predetermined age. According to an exemplary embodiment of the first aspect, the information content can comprise, for example, World Wide Web content or any suitable type of information content.

According to a second aspect of the present invention, a method of rating information content, comprising the steps of: a.) displaying information content and an associated plurality of rating levels to users; b.) rating the information content by assigning one of the plurality of rating levels to the information content by the users; c.) assigning a weight to each user rating in accordance with a historical rating accuracy of each user; and d.) generating a weighted average consensus rating of the information content in accordance with the weighted user ratings.

According to the second aspect, step (d) can comprise the step of: e.) calculating a mean of the weighted user ratings to generate the consensus rating of the information content. Alternatively, step (d) can comprise the step of: f.) calculating a median of the weighted user ratings to generate the consensus rating of the information content. The method can include the step of: g.) designating the information content as one of the plurality of rating levels in accordance with the consensus rating. The plurality of rating levels can comprise numerical ratings and/or discrete ratings. For example, the discrete ratings can comprise one of an “A” (“All ages allowed”) rating representing that the information content is suitable for all ages, a “B” (“Basic Guidance”) rating representing that the information content includes material that may not be suitable for young children, a “C” (“Caution”) rating representing that the information content includes material that may be inappropriate for children under a first predetermined age, a “D” (“Discretion Required”) rating representing that the information content is limited to those at least a second predetermined age or minors accompanied by a parent or adult guardian, and an “EX” (“Explicit Content”) rating representing that the information content is not for access by children under the second predetermined age.

According to the second aspect, each rating submitted by each user can be associated with characteristic information for identifying the user. The method can include the step of: h.) capturing the characteristic information associated with the users for generating historical rating information for the users. The method can also include the step of: i.) modifying the user rating in accordance with the historical rating information of the user. The historical rating accuracy of each user is determined in accordance with the deviation of the user rating from the consensus rating. The method can include one or more of the following steps: j.) increasing the weight assigned to the user rating when the user rating is within a predetermined deviation from the consensus rating; k.) decreasing the weight assigned to the user rating when the user rating is outside the predetermined deviation from the consensus rating; l.) assigning a second weight to the user rating in accordance with a frequency of accurate ratings made by the user; m.) assigning a third weight to the user rating in accordance with a frequency of inaccurate ratings made by the user; n.) combining the historical accuracy rating weight, the second weight associated with the number of accurate ratings made by the user, and the third weight associated with the number of inaccurate ratings made by the user to generate an overall weight for the user rating; o.) modifying the weight assigned to the user rating in accordance with the length of time that the user has been performing ratings; and p.) generating an official rating of the information content when the consensus rating exceeds a predetermined threshold. According to an exemplary embodiment of the second aspect, the predetermined threshold can comprise the total number of user ratings submitted for the information content.

According to the second aspect, the method can include one or more of the following steps: q.) screening user ratings for fraud in accordance with a deviation of the user rating from the consensus rating; r.) decreasing the weight assigned to the user rating when the user rating is determined to be fraudulent; s.) restricting user access to the information content in accordance with the consensus rating; t.) verifying an age of the user; and u.) denying user access to the information content when the age of the user is below a predetermined age. According to an exemplary embodiment of the second aspect, the information content can comprise, for example, World Wide Web content or any suitable type of information content.

According to a third aspect of the present invention, a decentralized system for rating information content includes a server computer and a plurality of client computers in communication with the server computer. The server computer is configured to cause the display, on at least one of the plurality of client computers, of the information content and an associated plurality of rating levels for rating the information content. Users on the client computers assign one of the plurality of rating levels to the information content. The server computer is configured to assign a weight to each user rating in accordance with a deviation of the user rating from a weighted average consensus rating of the information content. The server computer is further configured to generate the weighted average consensus rating of the information content in accordance with the weighted user ratings.

According to the third aspect, the server computer can be configured to generate the consensus rating of the information content by calculating a mean of the weighted user ratings. Each rating submitted by each user can be associated with characteristic information for identifying the user. The server computer can be configured to capture the characteristic information associated with the users for generating historical rating information for the users. The server computer can be configured to modify the user rating in accordance with historical rating information of the user. The server computer can be configured to increase the weight assigned to the user rating when the user rating is within the predetermined deviation from the consensus rating, and to decrease the weight assigned to the user rating when the user rating is outside the predetermined deviation from the consensus rating. The server computer can be configured to assign a second weight to the user rating in accordance with a frequency of accurate ratings made by the user. The server computer can be configured to assign a third weight to the user rating in accordance with a frequency of inaccurate ratings made by the user. The server computer can be configured to generate an overall weight for a user rating by combining the weight assigned to each user rating in accordance with the deviation of the user rating from the weighted average consensus rating, the second weight associated with the number of accurate ratings made by the user, and the third weight associated with the number of inaccurate ratings made by the user.

According to the third aspect, the server computer can be configured to modify the weight assigned to the user rating in accordance with the length of time that the user has been performing ratings. The server computer can be configured to screen user ratings for fraud in accordance with the deviation of the user rating from the consensus rating, and to decrease the weight assigned to the user rating when the user rating is determined to be fraudulent. The server computer can be configured to restricting user access to the information content in accordance with the consensus rating. The server computer can also be configured to verify the age of the user, and to deny user access to the information content when the age of the user is below a predetermined age.

According to a fourth aspect of the present invention, a method of decentralized rating of information content includes the steps of: a.) displaying the information content and an associated plurality of rating levels for rating the information content by users; b.) assigning one of the plurality of rating levels to the information content to generate a user rating; c.) assigning a weight to each user rating in accordance with a deviation of the user rating from a weighted average consensus rating of the information content; and d.) generating the weighted average consensus rating of the information content in accordance with the weighted user ratings.

According to the fourth aspect, step (d) can comprise the step of: e.) calculating a mean of the weighted user ratings to generate the consensus rating of the information content. Each rating submitted by each user can be associated with characteristic information for identifying the user. The method can include one or more of the following steps: f.) capturing the characteristic information associated with the users for generating historical rating information for the users; g.) modifying a user rating in accordance with historical rating information of the user; h.) increasing the weight assigned to the user rating when the user rating is within a predetermined deviation from the consensus rating; i.) decreasing the weight assigned to the user rating when the user rating is outside the predetermined deviation from the consensus rating; j.) assigning a second weight to the user rating in accordance with a frequency of accurate ratings made by the user; k.) assigning a third weight to the user rating in accordance with a frequency of inaccurate ratings made by the user; l.) combining the weight assigned to each user rating in accordance with a deviation of the user rating from the weighted average consensus rating, the second weight associated with the number of accurate ratings made by the user, and the third weight associated with the number of inaccurate ratings made by the user to generate an overall weight for a user rating; m.) modifying the weight assigned to the user rating in accordance with a length of time that the user has been performing ratings; n.) screening user ratings for fraud in accordance with a deviation of the user rating from the consensus rating; o.) decreasing the weight assigned to the user rating when the user rating is determined to be fraudulent; p.) restricting user access to the information content in accordance with the consensus rating; q.) verifying an age of the user; and r.) denying user access to the information content when the age of the user is below a predetermined age.

According to a fifth aspect of the present invention, a system for rating information content includes means for displaying information content. The information content displaying means is configured to display information content and an associated plurality of rating levels to users. The plurality of rating levels are configured for rating the information content by the users. The system includes means for generating ratings in communication with the information content displaying means. The ratings generating means is configured to receive ratings assigned by the users to the information content in accordance with the plurality of rating levels. The ratings generating means is configured to assign a weight to each user rating in accordance with a historical rating accuracy of each user. The ratings generating means is further configured to generate a weighted average consensus rating of the information content in accordance with the weighted user ratings.

According to the fifth aspect, the ratings generating means can be configured to generate the consensus rating of the information content by calculating a mean of the weighted user ratings. The ratings generating means can be configured to generate the consensus rating of the information content by calculating the median of the weighted user ratings. The ratings generating means can be configured to designate the information content as one of the plurality of rating levels in accordance with the consensus rating. The plurality of rating levels can comprise numerical ratings and/or discrete ratings. For example, the discrete ratings can comprise one of an “A” (“All ages allowed”) rating representing that the information content is suitable for all ages, a “B” (“Basic Guidance”) rating representing that the information content includes material that may not be suitable for young children, a “C” (“Caution”) rating representing that the information content includes material that may be inappropriate for children under a first predetermined age, a “D” (“Discretion Required”) rating representing that the information content is limited to those at least a second predetermined age or minors accompanied by a parent or adult guardian, and an “EX” (“Explicit Content”) rating representing that the information content is not for access by children under the second predetermined age.

According to the fifth aspect, each rating submitted by each user can be associated with characteristic information for identifying the user. The system can include means for capturing characteristic information in communication with the ratings generating means. The characteristic information capturing means can be configured to capture the characteristic information associated with the users for generating historical rating information for the users. The ratings generating means can be configured to modify a user rating in accordance with the historical rating information of the user. The ratings generating means can be configured to determine the historical rating accuracy of each user in accordance with the deviation of the user rating from the consensus rating. The ratings generating means can be configured to increase the weight assigned to the user rating when the user rating is within a predetermined deviation from the consensus rating, and to decrease the weight assigned to the user rating when the user rating is outside the predetermined deviation from the consensus rating. The ratings generating means can be configured to assign a second weight to the user rating in accordance with the frequency of accurate ratings made by the user. The ratings generating means can be configured to assign a third weight to the user rating in accordance with the frequency of inaccurate ratings made by the user. The ratings generating means can be configured to generate an overall weight for the user rating by combining the historical accuracy rating weight, the second weight associated with the number of accurate ratings made by the user, and the third weight associated with the number of inaccurate ratings made by the user. The ratings generating means can be configured to modify the weight assigned to the user rating in accordance with the length of time that the user has been performing ratings. The ratings generating means can be configured to generate an official rating of the information content when the consensus rating exceeds a predetermined threshold. According to an exemplary embodiment of the fifth aspect, the predetermined threshold can comprise, for example, the total number of user ratings submitted for the information content.

According to the fifth aspect, the system can include means for determining fraud in communication with the rating generation module. The fraud determining means can be configured to screen user ratings for fraud in accordance with the deviation of the user rating from the consensus rating. The ratings generating means can be configured to decrease the weight assigned to the user rating when the user rating is determined to be fraudulent by the fraud determination module. The system can include means for restricting information content in communication with the ratings generating means. The information content restricting means can be configured to restrict user access to the information content in accordance with the consensus rating. The system can include means for verifying age in communication with the information content restricting means. The age verifying means can be configured to verify the age of the user. The information content restricting means can be configured to deny user access to the information content when the age of the user is below a predetermined age. According to an exemplary embodiment of the fifth aspect, the information content can comprise, for example, World Wide Web content or any suitable type of information content.

According to a sixth aspect of the present invention, a computer-readable medium contains a computer program for rating information content. The computer program performs the steps of: a.) causing the display of information content and an associated plurality of rating levels to users; b.) receiving rating information from the user for rating the information content, wherein the rating information is generated by the users assigning one of the plurality of rating levels to the information content; c.) assigning a weight to each user rating in accordance with a historical rating accuracy of each user; and d.) generating a weighted average consensus rating of the information content in accordance with the weighted user ratings.

According to the sixth aspect, for step (d) the computer program can perform the step of: e.) calculating a mean of the weighted user ratings to generate the consensus rating of the information content. Alternatively, for step (d) the computer program can perform the step of: f.) calculating a median of the weighted user ratings to generate the consensus rating of the information content. The computer program can perform the step of: g.) designating the information content as one of the plurality of rating levels in accordance with the consensus rating. The plurality of rating levels can comprise numerical ratings and/or discrete ratings. For example, the discrete ratings can comprise one of an “A” (“All ages allowed”) rating representing that the information content is suitable for all ages, a “B” (“Basic Guidance”) rating representing that the information content includes material that may not be suitable for young children, a “C” (“Caution”) rating representing that the information content includes material that may be inappropriate for children under a first predetermined age, a “D” (“Discretion Required”) rating representing that the information content is limited to those at least a second predetermined age or minors accompanied by a parent or adult guardian, and an “EX” (“Explicit Content”) rating representing that the information content is not for access by children under the second predetermined age.

According to the sixth aspect, each rating submitted by each user can be associated with characteristic information for identifying the user. The computer program can perform one or more of the following steps: h.) capturing the characteristic information associated with the users for generating historical rating information for the users; and i.) modifying a user rating in accordance with the historical rating information of the user. The historical rating accuracy of each user can be determined in accordance with the deviation of the user rating from the consensus rating. The computer program can perform one or more of the following the steps: j.) increasing the weight assigned to the user rating when the user rating is within a predetermined deviation from the consensus rating; k.) decreasing the weight assigned to the user rating when the user rating is outside the predetermined deviation from the consensus rating; l.) assigning a second weight to the user rating in accordance with a frequency of accurate ratings made by the user; m.) assigning a third weight to the user rating in accordance with a frequency of inaccurate ratings made by the user; n.) combining the historical accuracy rating weight, the second weight associated with the number of accurate ratings made by the user, and the third weight associated with the number of inaccurate ratings made by the user to generate an overall weight for the user rating; o.) modifying the weight assigned to the user rating in accordance with a length of time that the user has been performing ratings; and p.) generating an official rating of the information content when the consensus rating exceeds a predetermined threshold. According to an exemplary embodiment of the sixth aspect, the predetermined threshold can comprise the total number of user ratings submitted for the information content.

According to the sixth aspect, the computer program can perform one or more of the following steps: q.) screening user ratings for fraud in accordance with the deviation of the user rating from the consensus rating; r.) decreasing the weight assigned to the user rating when the user rating is determined to be fraudulent; s.) causing user access to the information content to be restricted in accordance with the consensus rating; t.) verifying an age of the user; and u.) causing user access to the information content to be denied when the age of the user is below a predetermined age. According to an exemplary embodiment of the sixth aspect, the information content can comprise, for example, World Wide Web content or any suitable type of information content.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for rating information content, in accordance with an exemplary embodiment of the present invention.

FIG. 2 is a block diagram illustrating a decentralized system for rating information content, in accordance with an alternative exemplary embodiment of the present invention.

FIG. 3 is a flowchart illustrating steps for rating information content, in accordance with an exemplary embodiment of the present invention.

### DETAILED DESCRIPTION OF THE PREFERRED EMBODIMENTS

Exemplary embodiments of the present invention are directed to a fraud-resistant and decentralized system and method for rating information content. The rating system of the present invention can be used, for example, as a self-regulatory system for any suitable type of information content, such as, for example, World Wide Web or Internet content or the like. For example, each member can self-rate their overall website, as well as each individual post within a website. Each post can be rated not only by the author, but also by any other member of the website. In this way, website administrators can verify that the post is accurately rated. If it is not, then the website administrators can increase the rating of that post (and, potentially, the rating of the site overall). Additional algorithms can be used to screen out fraudulent ratings that attempt to fool the rating system of the present invention. It is noted that the rating system according to exemplary embodiments differs from the MPAA and ESRB systems in several respects. In particular, rather than depending on a centralized body to rate each piece of content, the rating system according to exemplary embodiments uses a decentralized model. Any user can rate any other user (or post) on a website. The user or post ratings are determined by a suitable mathematical combination of all of these ratings.

According to exemplary embodiments, the fraud-resistant, decentralized rating system can calculate ratings for content based on, for example, self rating of content by the author, rating of the content by others, computerized ratings algorithms, and other like factors and methods. The decentralized rating system can weight each rating using several suitable weights, each of which can attempt to capture the historical accuracy (or inaccuracy) of each rater. Then, a weighted average can be computed that results in a single consensus rating for each piece of content. Fraudulent raters can be quickly detected and given a weight so low as to be effectively ignored in the consensus rating. The result is a system that is both decentralized and fraud-resistant. The consensus ratings can also be used to restrict access to content. For example, posts that have been rated to include adult content (e.g., corresponding to a rating such as an R or NC-17 rating in the MPAA system) can restrict access to users who have proven their age (or demonstrated consent from their parent or legal guardian).

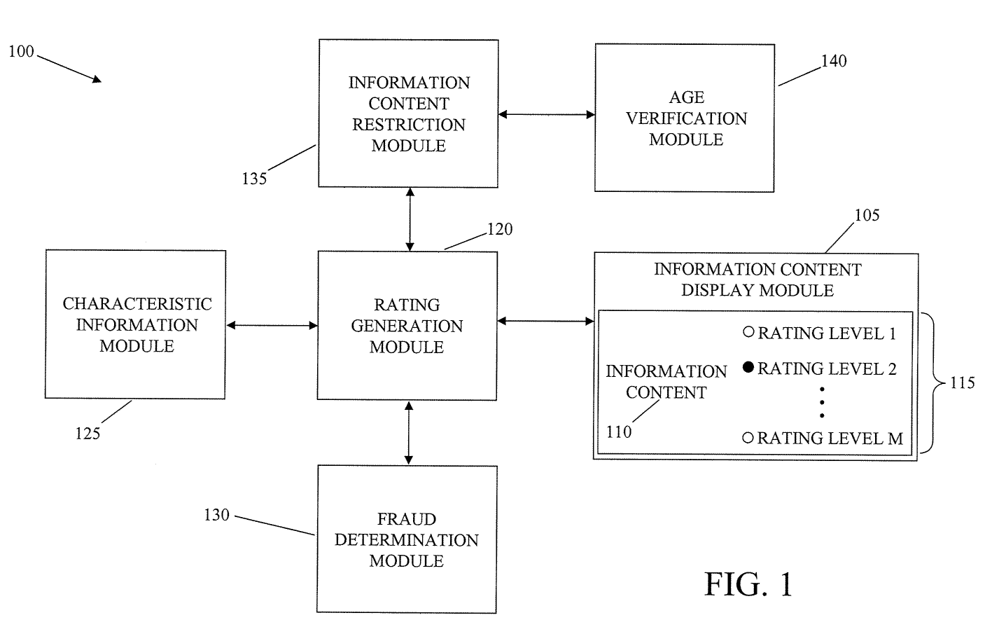

These and other aspects and embodiments of the present invention will now be described in greater detail. FIG. 1 is a block diagram illustrating a system 100 for rating information content, in accordance with an exemplary embodiment of the present invention. As used herein, “information content” includes any suitable type of media, multimedia, or other information content that is capable of being viewed by, displayed or presented to, or otherwise accessed by users, including information available via the World Wide Web or Internet, or that which can be delivered over any suitable distribution channel (e.g., mobile/wireless, broadcast, retail, and other like channels). For example, information content can include such media as books or DVDs, digital music tracks, digital photos (e.g., camera-phone snapshots that can be sent over a mobile carrier network), and any other like information content.

The system 100 includes an information content display module 105. The information content display module 105 is configured to display information content 110 and an associated plurality of rating levels 115 to users. The plurality of rating levels 115 are configured for rating the information content 110 by the users. According to exemplary embodiments, any suitable number and type of rating levels 115 can be used for rating the information content (e.g., rating level 1, rating level 2, rating level 3, . . . , rating level M, where M can be any appropriate number). The information content display module 105 can provide the graphical and/or textual interface through which the users or raters interact with the system 100 to rate the information content 110. For example, the information content display module 105 can be configured to display the information content 110 and rating levels 115 through a suitable Web browser (e.g., Internet Explorer, Netscape Navigator, Firefox, Safari, Opera, or any other suitable Web browser) on a computer monitor or other appropriate display device, whether portable or (substantially) fixed.

The system 100 includes a rating generation module 120 in communication with the information content display module 105. The rating generation module 120 is configured to receive ratings assigned by the users to the information content 110 in accordance with the plurality of rating levels 115. A user or rater can assign a rating to a piece of information content 110 by appropriately selecting or otherwise choosing one of the plurality of rating levels 115 that can be displayed along with the information content 110 by the information content display module 105 (e.g., via a pull-down or pop-up menu displayed or otherwise associated with the piece of information content 110). The rating generation module 120 is configured to assign a weight to each user rating in accordance with a historical rating accuracy of each user. The rating generation module 120 is also configured to generate or otherwise calculate a weighted average consensus rating of the information content 110 in accordance with the weighted user ratings. According to exemplary embodiments, the rating generation module 120 can be configured to generate the consensus rating of the information content 110 by calculating the mean or average of the weighted user ratings. Alternatively, the rating generation module 120 can be configured to generate the consensus rating of the information content 110 by calculating the median of the weighted user ratings. Those of ordinary skill in the art will recognize that other suitable algorithms can be used to generate the weighted average consensus rating. The rating generation module 120 is configured to designate the information content 110 as one of the plurality of rating levels 115 in accordance with the consensus rating.

According to exemplary embodiments, the plurality of rating levels can comprise either numerical or discrete ratings or a suitable combination of numerical and discrete ratings. For example, in a numerical rating system, each piece of information content 110 can be rated with a number (e.g., 1-5 stars or other like numerical rating). According to such an exemplary embodiment, the weighted average consensus rating can be calculated by the rating generation module 120 using, for example, the mean rating (using weights as appropriate, as discussed below) or other suitable algorithm (e.g., the median rating). In a discrete rating system, symbolic, graphical, or other letter designations can be used to represent rating levels 115. Various discrete rating level designations can be used as part of the rating system 100 of the present invention. Merely for purposes of illustration and not limitation, the following discrete rating level designations can be used:
A—All ages allowed.
B—Basic Guidance. Some material may not be suitable for young children.
C—Caution. Some material may be inappropriate for children under 13.
D—Discretion Required. Parent of Guardian approval required for minors.
EX—Explicit Content. Adults only, no one under 18 allowed.
   The first predetermined age of 13 and the second predetermined age of 18 can each be any suitable age, depending on the desired level of access restriction to the information content 110 (e.g., raising/lowering either or both of the age limits to decrease/increase restrictions on access to the information content 110, respectively). However, any suitable additional or alternative discrete rating level designations can be used to rate the information content 110 according to exemplary embodiments.

The MPAA film ratings system is a particular example of a discrete rating system, with each rating letter representing a recommended level of age appropriateness (e.g., G, PG, PG-13, R, NC-17). According to an exemplary embodiment, the weighted average consensus rating can be calculated by the rating generation module 120 using, for example, either the median or mode of the rating letters (e.g., A, B, C, D, and EX). Alternatively, each discrete rating can be converted into a suitable number or value equivalent. Merely for purposes of illustration and not limitation, each discrete rating letter can be converted into a number using an appropriate look-up table or the like, such as illustrated in Table 1:

TABLE 1

| Rating | Numerical Equivalent |
|---|---|
| A | 0 |
| B | 25 |
| C | 50 |
| D | 75 |
| EX | 100 |

Such a look-up table can be maintained by, stored in, or be otherwise accessible by the rating generation module 120 for converting a rating letter designation into the corresponding numerical value. Those of ordinary skill in the art will recognize that each discrete rating can be converted to or otherwise associated with any suitable number or value equivalent. The numerical equivalents can be used to calculate the mean rating (using weights as appropriate, as discussed below) or other suitable numerical rating, as described above for the numerical rating system. After the weighted mean rating is computed, the weighted mean rating can be converted back into a discrete rating using pre-defined or otherwise predetermined ranges (e.g., via an appropriate look-up table). In other words, if the weighted mean rating falls within a particular range, the corresponding discrete rating is used. The predetermined ranges can be of any suitable numerical values, and can be conservative or liberal, depending on whether or not the bulk of the range is above or below each numerical rating. Merely for purposes of illustration and not limitation, the pre-defined ranges listed in Table 2 could tend to result in conservative ratings:

TABLE 2

| Rating | Pre-defined Ranges |
|---|---|
| A | 0–8.33 |
| B | 8.34–33.33 |
| C | 33.34–58.66 |
| D | 58.67–83.66 |
| EX | 83.66–100 |

According to exemplary embodiments, there can be three types of raters for the system 100 that can provide ratings input for the rating generation module 120 via the information content display module 105: 1.) self-raters; 2.) other raters, who can rate of the information content 110 created by others; and 3.) computerized or automatic raters. Suitable additional and alternative raters can also be used for providing rating input to the system 100.

For self-raters, each piece of information content 110 can be self-rated by the author of that information content 110. Additionally or alternatively, the system 100 supports third-party raters who can rate the information content 110 created by others. According to exemplary embodiments, any user viewing a piece of information content 110 can rate it. According to an additional exemplary embodiment, each rating can be tied to or otherwise associated with a suitable identifying characteristic. In other words, each rating submitted by each user can be associated with characteristic information for identifying the user. The system 100 can include a characteristic information module 125 in communication with the rating generation module 120. The characteristic information module 125 can be configured to capture the characteristic information associated with the users for generating historical rating information for the users. Such characteristic information can include any suitable type of identifying characteristics, ranging from a unique identifier (e.g., a unique nickname, a user identification (ID), a social security number, telephone number, a browser cookie ID, or the like) to an approximate identifier that can be shared with others (e.g., an IP address). By tying or otherwise associating each rating to a unique (or substantially unique) identifier, the historical accuracy of the rater can be calculated. Such historical accuracy enables the ratings algorithm to weight, up or down, the rating of each user, as discussed below. In other words, as a user rates more information content 110, a weight associated with that user's ratings can be increased or decreased over time depending on the accuracy (or inaccuracy) of the user's ratings. Consequently, the ratings of users who provide more accurate ratings over time can be given greater weight than the users who provide less accurate or inaccurate ratings. Thus, the rating generation module 120 can be configured to modify a user rating in accordance with the historical rating information of the user.

Additionally or alternatively, each piece of information content 110 can be automatically analyzed by suitable computer algorithms and assigned an appropriate rating. For example, text content can be parsed for profanity and other words that tend to be associated with content appropriate for a mature audience. Photographic or video content can be analyzed for telltale signs of adult content (e.g., high prevalence of skintone colors, and the like) using suitable image processing algorithms. These ratings can be combined with the other ratings, and weighted appropriately according to the historical accuracy used by each algorithm. It is noted that some computerized analysis of multimedia content could over-report the likelihood of adult content (e.g., baby photos could be flagged as potentially being adult, due to the high prevalence of skin tones). As a result, the weights of multimedia algorithmic rating can vary according to their effectiveness for a given author, as opposed to being weighted according to their effectiveness across all authors. In such a manner, an author tending to post baby photos can have the computerized weighting of any multimedia algorithms decreased, since historically (for that author) the computerized multimedia algorithm may not be accurately predicting the appearance of adult content.

Additionally, the appearance of multimedia within a textual post can result in several computerized algorithmic ratings within a single post of information content 110. According to exemplary embodiments, these ratings can be combined as appropriate. For example, if a known adult photo appears within an otherwise age-appropriate post, the overall rating of that post can be adjusted upwards. Alternatively, if a photo or video of unknown rating appears within a textual post, the computerized rating of the textual post can be adjusted upwards to reflect the danger that the photo or video may contain adult content. Other suitable adjustments to the computerized ratings can also be performed as appropriate.

According to exemplary embodiments, each rater can be assigned one or more of a series of suitable weights, based on, for example, the historical accuracy of the rater. For example, the rating generation module 120 is configured to determine the historical rating accuracy of each user in accordance with the deviation of the user rating from the consensus rating. More particular, a historical accuracy rating weight can be based on the average deviation from the weighted average consensus rating of each post. For example, if a rater is historically precisely accurate, that rater can have the highest possible historical accuracy rating weight. In other words, as a user rates more information content 110, the historical accuracy rating weight associated with that user's ratings can be increased or decreased over time depending on the accuracy (or inaccuracy) of the user's ratings. By maintaining such a “history” of the accuracy (or inaccuracy) of the user's ratings, the ratings of users who provide more accurate ratings over time can be given greater weight than the users who provide less accurate or inaccurate ratings.

To encourage raters to be conservative with self-rating their own content, the historical accuracy rating weight of a user need not be adjusted down if an author self-rates their content more conservatively than the weighted average consensus rating. If the rating system 100 wishes to especially “punish” or deter raters who are inaccurate, a sum of least squares or other suitable algorithm can be used to disproportionately “punish” these outliers (e.g., if one rater averages twice as far from the weighted average as a second rater, the second rater can have a weight ¼ lower than the first, rather than ½). Additionally, as noted above, computerized algorithms rating content can have separate weights for their effectiveness for each individual content author. Accordingly, the rating generation module 120 can be configured to increase the weight assigned to the user rating when the user rating is within a predetermined deviation from the consensus rating, and can be configured to decrease the weight assigned to the user rating when the user rating is outside the predetermined deviation from the consensus rating. The extent of the predetermined deviation and the amount of increase/decrease of the historical accuracy rating weight will depend on factors such as, for example, the desirability of conservative ratings, the desire to “punish” or deter inaccurate raters, and other like factors.

According to exemplary embodiments, the rating generation module 120 can be configured to assign a second weight to the user rating in accordance with the frequency of accurate ratings made by the user. More particularly, the frequency of accurate ratings can be an additional weight (e.g., “Positive PowerCounts”) that can allow the rating generation module 120 to take into account how many accurate ratings have been made by a rater. “Accurate” can be defined by each system. For example, according to an exemplary embodiment, “accurate” can be defined as being within 25% of the weighted average rating, although any suitable definition of “accuracy” can be used. Merely for purposes of illustration and not limitation, if a rater has rated 100 pieces of content, and 80 of those ratings are within 25% of the weighted average rating (e.g., 12.5% above or below the weighted average rating), then the rater can receive 80 Positive PowerCount points.

According to an additional exemplary embodiment, the rating generation module 120 can be configured to assign a third weight to the user rating in accordance with the frequency of inaccurate ratings made by the user. More particularly, the frequency of inaccurate ratings can be an additional weight (e.g., “Negative PowerCounts”) that can allow the rating generation module 120 to take into account how many inaccurate ratings have been made by a rater. “Inaccurate” can be defined by each system. For example, according to an exemplary embodiment, “inaccurate” can be defined as being outside of 25% of the weighted average rating, although any suitable definition of “inaccuracy” can be used. Merely for purposes of illustration and not limitation, if a rater has rated 100 pieces of content, and 20 of those ratings are outside 25% of the weighted average rating (i.e., 80 of those rating are within 25% of the weighted average rating), then the rater can receive 20 Negative PowerCount points.

The rating generation module 120 can be configured to generate an overall weight for a user rating by combining the historical accuracy rating, the second weight (i.e., the frequency of accurate ratings made by the user), and the third weight (i.e., the frequency of inaccurate ratings made by the user). In other words, the previously-described weights (Historical Accuracy Rating Weight, Positive PowerCounts, and Negative PowerCounts) can be combined to create an overall weight for each rater. Any suitable type of combination of these weights can be performed by the rating generation module 120 to generate the overall weight. Merely for purposes of illustration and not limitation, the Negative PowerCounts can be subtracted from the Positive PowerCounts, to result in an overall number of PowerCount Points (e.g., if the overall number is negative, then the net number of PowerCount Points can be zero). Such a net number of PowerCount points can be multiplied by the Historical Accuracy Rating Weight to result in an Overall Weight for each user/rater.

Other suitable adjustments to the weights can be made as needed by the rating generation module 120 to improve the resistance of the Overall Weights to fraudulent ratings. For example, if certain new raters (e.g., a new member, an IP address that has never been used to rate a piece of content before, or the like) are believed to be more likely to be fraudulent, their overall weights can be adjusted downward on a percentage or other suitable basis.

According to an exemplary embodiment, the rating generation module 120 can be configured to modify the overall weight assigned to the user rating in accordance with the length of time that the user has been performing ratings. For example, new raters can have their ratings multiplied by a fraction representing their “age” at the time of the rating, divided by the number of days before the rater is considered to be a valid rater. For purposes of illustration and not limitation, suppose that raters are not considered valid until 7 days after their first rating. If a new member rated a piece of content at time zero, their overall weight would be multiplied by 0/7, or 0. If a new member rated a piece of content at day 1, their overall weight would be multiplied by 1/7, or approximately 0.14. Once the rater is considered “valid,” such age or time-based weighting can be removed for that rater.

According to an exemplary embodiment, the rating generation module 120 can be configured to generate an official rating of the information content 110 when the consensus rating exceeds a predetermined threshold. For example, the predetermined threshold can comprise the total number of user ratings submitted for the information content 110. More particularly, as a piece of information content 110 is rated by more raters (especially raters with a high Overall Weight), weighted average consensus rating of that information content 110 is increasingly likely to be accurate. Once a piece of information content 110 passes a certain suitable threshold (e.g., a total number of ratings, a total sum of Overall Weights, or other appropriate threshold), the consensus rating for that information content 110 can be designated as an Official Rating or the like. Other suitable information can also be indicated to users, such as how close a given piece of information content 110 is to achieving an Official Rating. Such an indication can be achieved by displaying, either numerically or graphically, via the information content display module 105 how close the piece of information content 110 is to reaching such a status (e.g., on a percentage or absolute basis).

According to an alternative exemplary embodiment, rather than assigning a variable weight to each user/rater, each user rating can be assigned a weight based on a predetermined binary (or other fixed) set of conditions in which one condition would cause the rating weight to equal zero, and the other would cause the rating weight to be one. For example, all trusted raters can have a rating weight of one, and all other raters can have a rating weight of zero. The level or threshold at which a rater becomes “trusted” will depend on various factors, including, for example, the historical accuracy demonstrated by such users, the “age” of such users (as described above), and other like factors.

According to exemplary embodiments, the system 100 can reduce or eliminate incidences of or attempts at fraudulent rating. The system 100 can include a fraud determination module 130 in communication with the rating generation module 120. The fraud determination module 130 can be configured to screen user ratings for fraud in accordance with the deviation of the user rating from the consensus rating. For example, if a user rating is significantly beyond or otherwise outside a predetermined deviation from the consensus rating, the user rating can be marked or otherwise indicated a potentially fraudulent. The rating generation module 120 can be configured to decrease the weight assigned to the user rating when the user rating is determined to be fraudulent by the fraud determination module 130. In such a manner, fraudulent raters can be quickly detected and given a weight so low as to be effectively ignored by the system 100.

Once a piece of information content 110 has been rated as containing adult content (e.g., “EX” (“Explicit Content”), according to an exemplary embodiment of the present invention), access to that information content 110 can be limited to viewers or other users who have verified that they are of sufficient age to view that content (or that they have parental consent to view that content). Accordingly, the system 100 can include an information content restriction module 135 in communication with the rating generation module 120. The information content restriction module 135 can be configured to restrict user access to the (restricted) information content 110 in accordance with the consensus rating. The system 100 can also include an age verification module 140 in communication with the information content restriction module 135. The age verification module 140 can be configured to verify the age of the user. Any suitable age verification method, means or algorithm can be used that is capable of verifying the age of a user so that access to the (restricted) information content 110 can be limited to users based on their age. Based on the verified age received from the age verification module 140, the information content restriction module 135 can be configured to deny user access to the information content 110 when the age of the user is below a predetermined age (e.g., 18 or any suitable age for “EX” (“Explicit Content”)). Access to the information content 110 can be denied by blocking, redacting, or otherwise preventing the display of or other access to such information content 110 by the user through the information content display module 105.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the rating generation module 120, the characteristic information module 125, the fraud determination module 130, the information content restriction module 135, and the age verification module 140 (or any combination of such modules) can be located extraterritorially to the United States (e.g., in Canada and/or in one or more other foreign countries). However, the information content display module 105 can be located within the United States, such that the control of the system 100 as a whole is exercised and beneficial use of the system 100 is obtained by the user within the United States.

Each of modules of the system 100, including information content display module 105, the rating generation module 120, the characteristic information module 125, the fraud determination module 130, the information content restriction module 135, and the age verification module 140, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying (e.g., electrical) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

The system 100 can include suitable additional modules as necessary to assist or augment the functionality of any or all of the modules of the system 100. For example, the system 100 can include a database module that can be in communication with, for example, the rating generation module 120. Such a database module can be configured to store any suitable type of information generated or used by or with the system 100, including, for example, rating information (including weights applied to user ratings), characteristic information of the users, information content 110, and other like information. Such a database module can be comprised of any suitable type of computer-readable or other computer storage medium capable of storing information in electrical or electronic form.

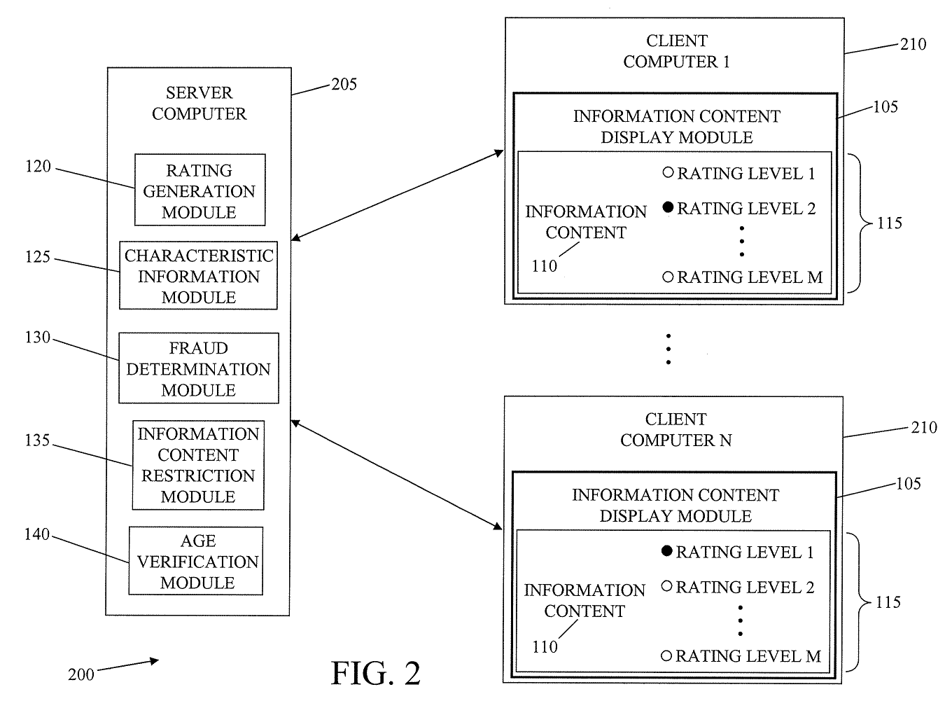

Alternative architectures or structures can be used to implement the various functions of the system 100 as described herein. For example, functions from two or more modules can be implemented in a single module, or functions from one module can be distributed among several different modules. FIG. 2 is a block diagram illustrating a decentralized system 200 for rating information content, in accordance with an alternative exemplary embodiment of the present invention.

The system 200 includes a server computer 205 and a plurality of client computers 210 in communication with the server computer 205. The server computer 205 can comprise any suitable type of server computer, workstation, or the like that is capable of communicating with, coordinating, and servicing requests from numerous, remote clients. Each of the client computers 210 can comprise any suitable type of general purpose computer, PC, portable device (e.g., PDA) or the like capable of displaying the information content 110 and the plurality of rating levels 115 to the user and allowing the user to interact with the system 200. Any suitable number of client computers 210 (e.g., client computer 1, client computer 2, . . . , client computer N, where N is any appropriate number) can be in communication with server computer 205. The server computer 205 is configured to cause the display of information content 110 and an associated plurality of rating levels 115, on at least one of the plurality of client computers 210, for rating the information content 110. For example, the server computer 205 can communicate with the information content display module 105 (discussed previously) that can reside on each client computer 210 to cause the display of such information. Users on the client computers 210 can assign one of the plurality of rating levels 115 to the information content 110 in the manner described previously. The server computer 205 is configured to assign a weight to each user rating in accordance with the deviation of the user rating from a weighted average consensus rating of the information content 110 (e.g., using the rating generation module 120 in the manner described previously). The server computer 205 is also configured to generate the weighted average consensus rating of the information content in accordance with the weighted user ratings (e.g., using the rating generation module 120 in the manner described previously).

According to the present alternative exemplary embodiment, the server computer 205 can be configured to generate the consensus rating of the information content 110 by calculating the mean of the weighted user ratings (e.g., using the rating generation module 120 in the manner described previously). Each rating submitted by each user can be associated with characteristic information for identifying the user. For example, the server computer 205 can be configured to capture the characteristic information associated with the users for generating historical rating information for the users (e.g., using the characteristic information module 125 in the manner described previously). The server computer 205 can be configured to modify the user rating in accordance with historical rating information of the user. The server computer 205 can be further configured to increase the weight assigned to the user rating when the user rating is within a predetermined deviation from the consensus rating, and configured to decrease the weight assigned to the user rating when the user rating is outside the predetermined deviation from the consensus rating (e.g., using the rating generation module 120 in the manner described previously). The server computer 205 can also be configured to assign a second weight to the user rating in accordance with the frequency of accurate ratings made by the user, and configured to assign a third weight to the user rating in accordance with the frequency of inaccurate ratings made by the user (e.g., using the rating generation module 120 in the manner described previously). Accordingly, the server computer 205 can be configured to generate an overall weight for a user rating by combining, in any suitable manner: i.) the weight assigned to each user rating in accordance with the deviation of the user rating from the weighted average consensus rating; ii.) the second weight associated with the number of accurate ratings made by the user; and iii.) the third weight associated with the number of inaccurate ratings made by the user. The server computer 205 can be further configured to modify the weight assigned to the user rating in accordance with the length of time that the user has been performing ratings (e.g., using the rating generation module 120 in the manner described previously).

In addition, the server computer 205 can be configured to screen user ratings for potential fraud in accordance with the deviation of the user rating from the consensus rating (e.g., using the fraud determination module 130 in the manner described previously), to restrict user access to the information content 110 in accordance with the consensus rating (e.g., using the information content restriction module 135 in the manner described previously), and to verify the age of the user (e.g., using the age verification module 140 in the manner described previously). Other alternative architectures or structures can be used to implement the various functions of the systems 100 and 200 as described herein.

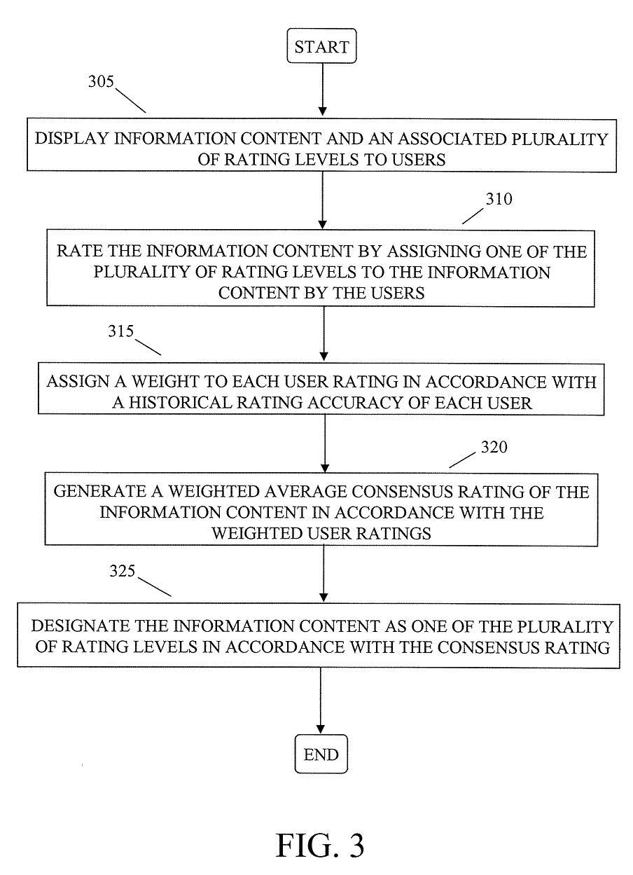

FIG. 3 is a flowchart illustrating steps for rating information content, in accordance with an exemplary embodiment of the present invention. In step 305, information content and an associated plurality of rating levels are displayed to users. In step 310, the information content is rated by assigning one of the plurality of rating levels to the information content by the users. In step 315, a weight is assigned to each user rating in accordance with a historical rating accuracy of each user. In step 320, a weighted average consensus rating of the information content is generated in accordance with the weighted user ratings. According to an exemplary embodiment, the consensus rating of the information content can be generated in step 320 by calculating the mean or the median of the weighted user ratings, although any suitable algorithm can be used to generate the consensus rating from the weighted user ratings. In step 325, the information content is designated as one of the plurality of rating levels in accordance with the consensus rating.

As discussed previously, the plurality of rating levels comprise numerical and/or discrete ratings. For purposes of illustration and not limitation, the discrete ratings comprise: an “A” (“All ages allowed”) rating representing that the information content is suitable for all ages; a “B” (“Basic Guidance”) rating representing that the information content includes material that may not be suitable for young children; a “C” (“Caution”) rating representing that the information content includes material that may be inappropriate for children under a first predetermined age (e.g., 13 or any suitable age); a “D” (“Discretion Required”) rating representing that the information content is limited to those at least a second predetermined age (e.g., 18 years or older, or any suitable age) or minors accompanied by a parent or adult guardian; and an “EX” (“Explicit Content”) rating representing that the information content is not for access by children under the second predetermined age (e.g., 18 or any suitable age). However, any suitable symbolic, graphical, or other letter designations can be used to represent such discrete rating levels.

Each rating submitted by each user can be associated with characteristic information for identifying the user. For example, the method can include the steps of capturing the characteristic information associated with the users for generating historical rating information for the users, and modifying a user rating in accordance with the historical rating information of the user. According to an exemplary embodiment, the historical rating accuracy of each user can be determined in accordance with the deviation of the user rating from the consensus rating. For example, the method can include the steps of increasing the weight assigned to the user rating when the user rating is within a predetermined deviation from the consensus rating, and decreasing the weight assigned to the user rating when the user rating is outside the predetermined deviation from the consensus rating.

The method can also include the steps of assigning a second weight to the user rating in accordance with the frequency of accurate ratings made by the user, and assigning a third weight to the user rating in accordance with the frequency of inaccurate ratings made by the user. Accordingly, the method can include the step of combining the historical accuracy rating weight, the second weight associated with the number of accurate ratings made by the user, and the third weight associated with the number of inaccurate ratings made by the user to generate the overall weight for the user rating. As discussed previously, additional or alternative weighting can be applied to each user rating. For example, the method can include the step of modifying the weight assigned to the user rating in accordance with the length of time that the user has been performing ratings. An “official rating” of the information content can be generated when the consensus rating exceeds a predetermined threshold (e.g., the total number of user ratings submitted for the information content or other like threshold).

According to present exemplary embodiment, incidents of fraudulent ratings can be reduced or eliminated by screening user ratings for fraud in accordance with a deviation of the user rating from the consensus rating, and decreasing the weight assigned to the user rating when the user rating is determined to be fraudulent. The present method can also be used to restrict access to material deemed too explicit for children (i.e., adult or mature content) based on the consensus rating. For example, the method can include the steps of verifying the age of the user, and denying user access to the information content when the age of the user is below a predetermined age for the consensus rating.

Each, all or any combination of the steps of a computer program as illustrated in FIG. 3 for rating information content can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process to compute ratings for any suitable information content, including information content other than Web or Internet content ratings. More particularly, exemplary embodiments of the present invention can be used to rate any suitable information content that can be delivered over any suitable distribution channel (e.g., Internet, mobile/wireless, broadcast, retail, and other like channels). For example, exemplary embodiments can be used to calculate weighted average consensus ratings for products such as books or DVDs, for retail outlets such as restaurants, for digital music tracks (e.g., that are sold through retail outlets with the ratings on them), for camera-phone snapshots that can be sent over a mobile carrier network carrying the appropriate rating, and the like. In addition, the rating system according to exemplary embodiments can be used to re-rate previously rated information content, such as to re-rate old movies that have already been rated by the MPAA, to update those ratings for modern community standards. Exemplary embodiments described herein can mitigate the issue of fraudulent ratings given by users hoping to falsely increase (or decrease) the average rating of an item in which they have an interest (e.g., an author rating their own book up on an online retailer site, or a hairdresser giving their own salon a high rating on a local city guide site).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for rating information content, comprising:
an information content display module,
wherein the information content display module is configured to display information content and an associated plurality of rating levels to users,
wherein the plurality of rating levels are configured for rating the information content by the users; and
a rating generation module in communication with the information content display module,
wherein the rating generation module is configured to receive ratings assigned by the users to the information content in accordance with the plurality of rating levels,
wherein the rating generation module is configured to assign a weight to each user rating in accordance with a historical rating accuracy of each user, and
wherein the rating generation module is configured to generate a weighted average consensus rating of the information content in accordance with the weighted user ratings.

2. The system of claim 1, wherein the rating generation module is configured to generate the consensus rating of the information content by calculating a mean of the weighted user ratings.

3. The system of claim 1, wherein the rating generation module is configured to designate the information content as one of the plurality of rating levels in accordance with the consensus rating.

4. The system of claim 1, wherein the plurality of rating levels comprise discrete ratings.

5. The system of claim 4, wherein the discrete ratings comprise one of an “A—All ages allowed” rating representing that the information content is suitable for all ages, a “B—Basic Guidance” rating representing that the information content includes material that may not be suitable for young children, a “C—Caution” rating representing that the information content includes material that may be inappropriate for children under a first predetermined age, a “D—Discretion Required” rating representing that the information content is limited to those at least a second predetermined age or minors accompanied by a parent or adult guardian, and an “EX—Explicit Content” rating representing that the information content is not for access by children under the second predetermined age.

6. The system of claim 1, wherein each rating submitted by each user is associated with characteristic information for identifying the user.

7. The system of claim 6, comprising:
a characteristic information module in communication with the rating generation module,
wherein the characteristic information module is configured to capture the characteristic information associated with the users for generating historical rating information for the users.

8. The system of claim 7, wherein the rating generation module is configured to modify a user rating in accordance with the historical rating information of the user.

9. The system of claim 1, wherein the rating generation module is configured to determine the historical rating accuracy of each user in accordance with a deviation of the user rating from the consensus rating.

10. The system of claim 9, wherein the rating generation module is configured to increase the weight assigned to the user rating when the user rating is within a predetermined deviation from the consensus rating, and
wherein the rating generation module is configured to decrease the weight assigned to the user rating when the user rating is outside the predetermined deviation from the consensus rating.

11. The system of claim 1, wherein the rating generation module is configured to assign a second weight to the user rating in accordance with a frequency of accurate ratings made by the user.

12. The system of claim 1, wherein the rating generation module is configured to assign a second weight to the user rating in accordance with a frequency of inaccurate ratings made by the user.

13. The system of claim 1, wherein the rating generation module is configured to generate an overall weight for the user rating by combining the historical accuracy rating weight, a second weight associated with the number of accurate ratings made by the user, and a third weight associated with the number of inaccurate ratings made by the user.

14. The system of claim 1, wherein the rating generation module is configured to modify the weight assigned to the user rating in accordance with a length of time that the user has been performing ratings.

15. The system of claim 1, wherein the rating generation module is configured to generate an official rating of the information content when the consensus rating exceeds a predetermined threshold.

16. The system of claim 15, wherein the predetermined threshold comprises a total number of user ratings submitted for the information content.

17. The system of claim 1, comprising:
a fraud determination module in communication with the rating generation module,
wherein the fraud determination module is configured to screen user ratings for fraud in accordance with a deviation of the user rating from the consensus rating, and
wherein the rating generation module is configured to decrease the weight assigned to the user rating when the user rating is determined to be fraudulent by the fraud determination module.

18. The system of claim 1, comprising:
an information content restriction module in communication with the rating generation module,
wherein the information content restriction module is configured to restrict user access to the information content in accordance with the consensus rating.

19. The system of claim 18, comprising:
an age verification module in communication with the information content restriction module,
wherein the age verification module is configured to verify an age of the user, and
wherein the information content restriction module is configured to deny user access to the information content when the age of the user is below a predetermined age.

20. The system of claim 1, wherein the information content comprises World Wide Web content.

21. A method of rating information content, comprising the steps of:
a.) displaying information content and an associated plurality of rating levels to users;
b.) rating the information content by assigning one of the plurality of rating levels to the information content by the users;
c.) assigning a weight to each user rating in accordance with a historical rating accuracy of each user; and
d.) generating a weighted average consensus rating of the information content in accordance with the weighted user ratings.

22. The method of claim 21, wherein step (d) comprises the step of:
e.) calculating a mean of the weighted user ratings to generate the consensus rating of the information content.

23. The method of claim 21, wherein the plurality of rating levels comprise discrete ratings.

24. The method of claim 23, wherein the discrete ratings comprise one of an “A—All ages allowed” rating representing that the information content is suitable for all ages, a “B—Basic Guidance” rating representing that the information content includes material that may not be suitable for young children, a “C—Caution” rating representing that the information content includes material that may be inappropriate for children under a first predetermined age, a “D—Discretion Required” rating representing that the information content is limited to those at least a second predetermined age or minors accompanied by a parent or adult guardian, and an “EX—Explicit Content” rating representing that the information content is not for access by children under the second predetermined age.

25. The method of claim 21, wherein each rating submitted by each user is associated with characteristic information for identifying the user.

26. The method of claim 25, comprising the step of:
e.) capturing the characteristic information associated with the users for generating historical rating information for the users.

27. The method of claim 26, comprising the step of:
f.) modifying a user rating in accordance with the historical rating information of the user.

28. The method of claim 21, wherein the historical rating accuracy of each user is determined in accordance with a deviation of the user rating from the consensus rating.

29. The method of claim 28, comprising the steps of:
e.) increasing the weight assigned to the user rating when the user rating is within a predetermined deviation from the consensus rating; and
f.) decreasing the weight assigned to the user rating when the user rating is outside the predetermined deviation from the consensus rating.

30. The method of claim 21, comprising the step of:
e.) assigning a second weight to the user rating in accordance with a frequency of accurate ratings made by the user.

31. The method of claim 21, comprising the step of:
e.) assigning a second weight to the user rating in accordance with a frequency of inaccurate ratings made by the user.

32. The method of claim 21, comprising the step of:
e.) combining the historical accuracy rating weight, a second weight associated with the number of accurate ratings made by the user, and a third weight associated with the number of inaccurate ratings made by the user to generate an overall weight for the user rating.

33. The method of claim 21, comprising the step of:
e.) modifying the weight assigned to the user rating in accordance with a length of time that the user has been performing ratings.

34. The method of claim 21, comprising the steps of:
e.) screening user ratings for fraud in accordance with a deviation of the user rating from the consensus rating; and
f.) decreasing the weight assigned to the user rating when the user rating is determined to be fraudulent.

35. The method of claim 21, comprising the step of:
e.) restricting user access to the information content in accordance with the consensus rating.

36. The method of claim 42, comprising the steps of:
f.) verifying an age of the user; and
g.) denying user access to the information content when the age of the user is below a predetermined age.

37. A decentralized system for rating information content, comprising:
a server computer; and
a plurality of client computers in communication with the server computer,
wherein the server computer is configured to cause the display, on at least one of the plurality of client computers, of the information content and an associated plurality of rating levels for rating the information content,
wherein users on the client computers assign one of the plurality of rating levels to the information content,
wherein the server computer is configured to assign a weight to each user rating in accordance with a deviation of the user rating from a weighted average consensus rating of the information content, and
wherein the server computer is configured to generate the weighted average consensus rating of the information content in accordance with the weighted user ratings.

38. A method of decentralized rating of information content, comprising the steps of:
a.) displaying the information content and an associated plurality of rating levels for rating the information content by users;
b.) assigning one of the plurality of rating levels to the information content to generate a user rating;
c.) assigning a weight to each user rating in accordance with a deviation of the user rating from a weighted average consensus rating of the information content; and
d.) generating the weighted average consensus rating of the information content in accordance with the weighted user ratings.
